(19) United States
(12) Patent Application Publication
(10) Pub. No.: US 2017/0013684 A1
(43) Pub. Date: Jan. 12, 2017

(54) LIGHTING DEVICE AND LIGHTING FIXTURE

(71) Applicant: Panasonic Intellectual Property Management Co., Ltd., Osaka (JP)

(72) Inventors: Hiroyuki ASANO, Nara (JP); Masato HIMEDA, Nara (JP); Masafumi YAMAMOTO, Kyoto (JP)

(21) Appl. No.: 15/194,750

(22) Filed: Jun. 28, 2016

(30) Foreign Application Priority Data
Jul. 7, 2015 (JP) 2015-136296

(51) Int. Cl. H05B 33/08; H05B 37/02

(52) U.S. Cl. CPC H05B 33/0815; H05B 37/02

(57) ABSTRACT

The lighting device includes a converter circuit including a switching device, a first inductor, and a second inductor. The first inductor and the second inductor have winding directions such that a magnetic field of the first inductor and a magnetic field of the second inductor have a canceling effect on each other. The switching device is mounted on the substrate so as to be present between the first inductor and the second inductor.

### CROSS-REFERENCE TO RELATED APPLICATION

The present application is based upon and claims the benefit of a priority of Japanese Patent Application No. 2015-136296, filed on Jul. 7, 2015, the entire contents of which are incorporated herein by reference.

### TECHNICAL FIELD

The present disclosure generally relates to lighting devices and lighting fixtures, and particularly to a lighting device for supplying power to light a light source and a lighting fixture including the same.

### BACKGROUND ART

In the past, there has been proposed a power supply device (lighting device) including a DC power supply and a chopper circuit for converting an output voltage of the DC power supply (as disclosed in Document 1 [JP 2015-65775 A]). The DC power supply includes an AC power supply and a rectifier. The chopper circuit includes a switching device, an output filter capacitor, a transformer, and a third inductor.

The transformer includes a first inductor, a second inductor, and a diode. The third inductor includes two fourth inductors with a same inductance. The two fourth inductors are connected in series with each other.

The two fourth inductors each have a structure in which a coil is wound around a drum core, and are arranged on a substrate to be close to each other. The coils are wound around the drum cores so that currents flow through the coils in opposite directions. The magnetic fields generated by the two fourth inductors thus have opposite directions, and such magnetic fields have a canceling effect on each other. Such cancellation of the magnetic fields may result in a weak magnetic field in a vicinity of the two fourth inductors. This may lead to a decrease in electromagnetic noise caused by the magnetic fields of the two fourth inductors.

In the power supply device disclosed in above Document 1, the two fourth inductors cooperate with the output filter capacitor to offer a function of smoothing a current resulting from switching of the switching device, and are arranged close to each other. In other words, above Document 1 discloses the power supply device but does not suggest that multiple inductors for realizing different functions are arranged close to each other.

Additionally, in the power supply device disclosed in above Document 1, other electronic parts are not situated in a space between the two fourth inductors arranged side by side, and the high-density packaging thus could not be realized.

### SUMMARY

In view of the above insufficiency, an objective of the present disclosure would be to propose a lighting device and a lighting fixture which are capable of realizing high-density packaging and reducing a disturbance voltage.

The lighting device of one aspect according to the present disclosure includes a converter circuit and a substrate. The converter circuit includes at least a switching device, a first inductor, and a second inductor. At least the switching device, the first inductor, and the second inductor are mounted on the substrate. The converter circuit is configured to, when the switching device is turned on, allow a first current to flow through the switching device by way of the first inductor and allow a second current to flow through the switching device by way of the second inductor in a direction same as a direction of the first current. The first inductor includes a first coil. The second inductor includes a second coil. The first inductor and the second inductor are mounted on the substrate and arranged side by side along an arrangement direction so as to cause interaction between a first magnetic field produced by the first current flowing through the first inductor and a second magnetic field produced by the second current flowing through the second inductor. The first coil of the first inductor and the second coil of the second inductor have winding directions such that the first magnetic field and the second magnetic field have a cancelling effect on each other. The switching device is mounted on the substrate so as to be present between the first inductor and the second inductor along the arrangement direction.

The lighting device of another aspect according to the present disclosure includes a converter circuit, a substrate, a pair of first coil terminals, and a pair of second coil terminals. The converter circuit includes at least a switching device, a first inductor, and a second inductor. At least the switching device, the first inductor, and the second inductor are mounted on the substrate. The first inductor includes a first coil. The second inductor includes a second coil. The pair of first coil terminals are individually electrically connected to opposite ends of the first coil of the first inductor. The pair of second coil terminals are individually electrically connected to opposite ends of the second coil of the second inductor. The converter circuit is configured to, when the switching device is turned on, allow a first current to flow through the switching device by way of the first inductor and allow a second current to flow through the switching device by way of the second inductor in a direction same as a direction of the first current. The first inductor and the second inductor are mounted on the substrate and arranged side by side along an arrangement direction so as to cause interaction between a first magnetic field produced by the first current flowing through the first inductor and a second magnetic field produced by the second current flowing through the second inductor. The first coil of the first inductor and the second coil of the second inductor have winding directions such that the first magnetic field and the second magnetic field have a cancelling effect on each other. The pair of first coil terminals and the pair of second coil terminals are mounted on a same edge of the substrate in a direction perpendicular to the arrangement direction.

The lighting device of another aspect according to the present disclosure includes a converter circuit and a substrate. The converter circuit includes at least a switching device, a first inductor, and a second inductor. At least the switching device, the first inductor, and the second inductor are mounted on the substrate. The converter circuit is configured to, when the switching device is turned on, allow a first current to flow through the switching device by way of the first inductor and allow a second current to flow through the switching device by way of the second inductor in a direction same as a direction of the first current. The first inductor includes a first coil. The second inductor includes a second coil. The first inductor and the second inductor are mounted on the substrate and arranged side by side along an arrangement direction so as to cause interaction between a first magnetic field produced by the first current flowing through the first inductor and a second magnetic field produced by the second current flowing through the second inductor. The first coil of the first inductor and the second coil of the second inductor have winding directions such that the first magnetic field and the second magnetic field have a cancelling effect on each other. The lighting device satisfies relations of L3<L1 and L3<L2. L1 represents an external dimension of the first inductor in the arrangement direction. L2 represents an external dimension of the second inductor in the arrangement direction. L3 represents an interval between the first inductor and the second inductor in the arrangement direction.

The lighting fixture of one aspect according to the present disclosure includes the lighting device of any one of the above aspects, and a light source to be lighted with lighting power supplied from the lighting device.

### BRIEF DESCRIPTION OF THE DRAWINGS

The figures depict one or more implementation in accordance with the present teaching, by way of example only, not by way of limitations. In the figures, like reference numerals refer to the same or similar elements.

FIG. 1 is a section of a lighting fixture according to one embodiment of the present disclosure, wherein the lighting fixture is installed.

FIG. 2 is a circuit diagram of a lighting device of the above embodiment.

FIG. 3 is a plan view of the lighting device of the above, wherein inductors and a switching device are mounted on a substrate.

FIG. 4 is a plan view of a model inductor for the lighting device of the above when viewed from the back.

FIG. 5 is a plan view of a lighting device of a comparative example, showing a relationship between currents flowing through inductors and magnetic fields produced by the currents.

FIG. 6 is a plan view of the lighting device of the above embodiment, showing a relationship between currents flowing through the inductors and magnetic fields produced by the currents.

FIG. 7 is a circuit diagram of a lighting device of a first modification of the above embodiment.

FIG. 8 is a plan view of the lighting device of the above, showing a relationship between currents flowing through inductors and magnetic fields produced by the currents.

FIG. 9 is a circuit diagram of a lighting device of a second modification of the above embodiment.

FIG. 10 is a plan view of the lighting device of the above, showing a relationship between currents flowing through inductors and magnetic fields produced by the currents.

### DETAILED DESCRIPTION

The following detailed descriptions referring to the drawings are made to lighting devices and lighting fixtures according to an embodiment of the present disclosure. Note that, the present embodiment is merely one example of embodiments of the present disclosure, and the embodiments of the present disclosure thus are not limited to the present embodiment. Accordingly, the present embodiment can be modified in various ways according to designs and/or the like, unless it still falls within a scope of the technical concept of the present disclosure.

As shown in FIG. 1, a lighting fixture 100 of the present embodiment is a ceiling embedded lighting fixture (e.g., a downlight) to be placed on an upper side of a ceiling so as to be exposed via an embedding hole 91 of a ceiling material 9. The lighting fixture 100 includes a lighting device 10, a light emitting unit 20, and a fixture body 30.

The fixture body 30 may be an aluminum die-casting product, for example. The fixture body 30 has a hollow cylindrical shape with one open end (lower face in FIG. 1). The fixture body 30 is fixed to the ceiling material 9 so as to be in the embedding hole 91 of the ceiling material 9. The fixture body 30 accommodates therein a substrate 201 on which multiple (three in the present embodiment) light emitting diodes (LEDs) 202 are mounted. The fixture body 30 is provided at its open end with a light diffusing plate 203 for diffusion light emitted from the LEDs 202.

In the present embodiment, the LEDs 202 constitute a light source. The substrate 201 on which the LEDs 202 are mounted, and the light diffusion plate 203 constitute the light emitting unit 20.

As shown in FIG. 1, in the lighting fixture 100 of the present embodiment, the light emitting unit 20 accommodated in the fixture body 30 and the lighting device 10 are spaced from each other. The lighting device 10 and the light emitting unit 20 are electrically interconnected by the power cables 7 connected together with a pair of connectors 8.

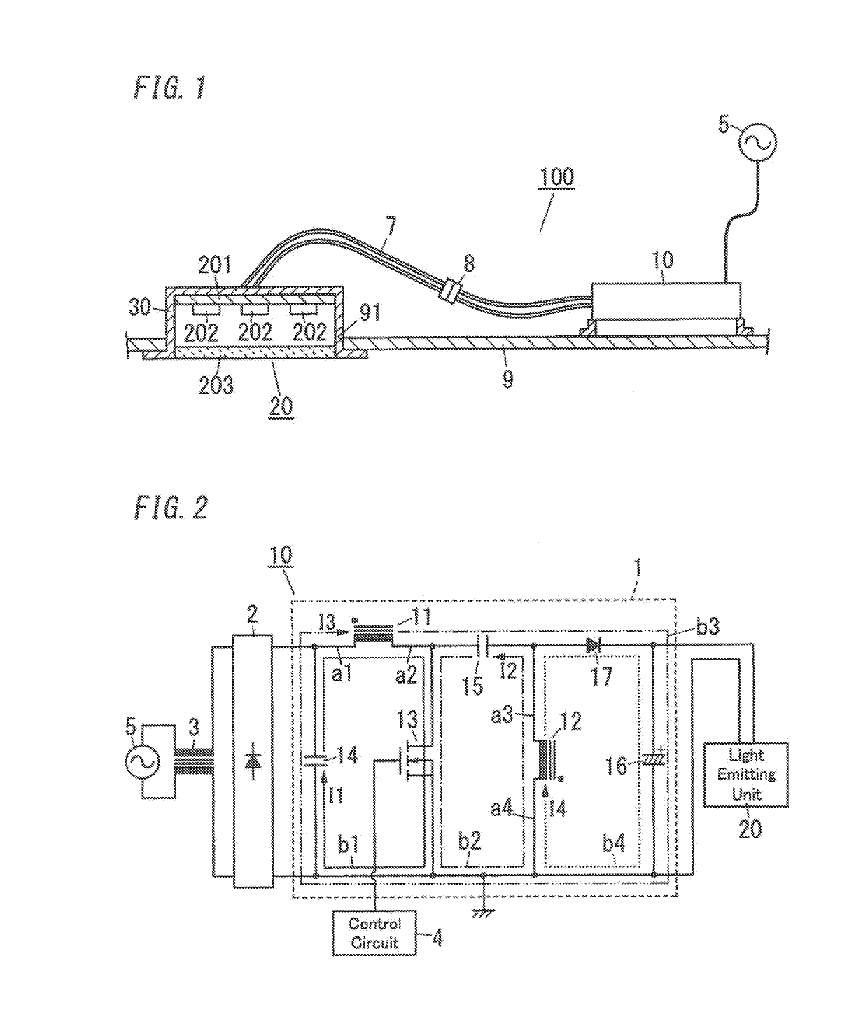

Next, the lighting device 10 of the present embodiment is described in detail with reference to a circuit diagram shown in FIG. 2. The lighting device 10 includes a converter circuit 1, a rectification circuit 2, a filter circuit 3, and a control circuit 4. These circuits are mounted on at least one of surfaces (front and rear surfaces) of a substrate 6 shown and described later.

The rectification circuit 2 may be a diode bridge including four diodes, for example. There is a capacitor 14 electrically connected between output terminals of the rectification circuit 2. The capacitor 14 smooths a pulsating voltage outputted from the rectification circuit 2 to produce a DC voltage.

The filter circuit 3 may be a low pass filter for cutting a high frequency component on a power supply line from an AC power supply 5, for example. The filter circuit 3 blocks the high frequency component so as to prevent the high frequency component from entering the rectification circuit 2.

The control circuit 4 may be a microcomputer, for example. The control circuit 4 is configured to generate a pulse width modulation (PWM) signal having a duty cycle according to a dimming level of a dimming signal inputted from an external device. Further, the control circuit 4 is configured to output the generated PWM signal to a switching device 13 of the converter circuit 1 described later. The switching device 13 is to be turned on and off according to the PWM signal from the control circuit 4.

The converter circuit 1 may correspond to a single ended primary inductor converter (SEPIC) circuit, for example. The converter circuit 1 includes a first inductor 11, a second inductor 12, a switching device 13, capacitors 14 to 16, and a diode 17.

The first inductor 11 has an end a1 (corresponding to a winding start point) electrically connected to a higher voltage side output terminal of the output terminals of the rectification circuit 2. The first inductor 11 has an end a2 (corresponding to a winding end point) electrically connected to a first end of the capacitor 15.

The capacitor 15 has a second end electrically connected to an anode of the diode 17. The diode 17 has a cathode electrically connected to a positive electrode of the capacitor 16. The capacitor 16 has a negative electrode electrically connected to a lower voltage side output terminal of the output terminals of the rectification circuit 2.

The switching device 13 may be an N-channel metal-oxide-semiconductor field-effect transistor (MOSFET), for example. The switching device 13 has a drain electrically connected to a connection point of the first inductor 11 and the capacitor 15. The switching device 13 has a source electrically connected to the lower voltage side output terminal of the rectification circuit 2. Further, the switching device 13 has a gate electrically connected to the control circuit 4.

The second inductor 12 has an end a3 (corresponding to a winding end point) electrically connected to a connection point between the capacitor 15 and the diode 17. The second inductor 12 has an end a4 (corresponding to a winding start point) electrically connected to the lower voltage side output terminal of the rectification circuit 2. The light emitting unit 20 (the LEDs 202) is electrically connected between opposite ends of the capacitor 16.

Hereinafter, operations of the lighting device 10 are described with reference to FIG. 2. When the switching device 13 is turned on according to the PWM signal from the control circuit 4, energy stored in the capacitor 14 causes a current I1 which flows through a path (represented by an arrow b1 in FIG. 2) from one end of the capacitor 14 to the other end of the capacitor 14 through the first inductor 11 and the switching device 13 in this order. Accordingly, electric energy would be stored in the first inductor 11.

Additionally, energy stored in the capacitor 15 causes a current I2 which flows through a path (represented by an arrow b2 in FIG. 2) from one end of the capacitor 15 to the other end of the capacitor 15 through the switching device 13 and the second inductor 12 in this order. Accordingly, electric energy would be stored in the second inductor 12.

When the switching device 13 is turned off according to the PWM signal from the control circuit 4, energy stored in the first inductor 11 causes a current I3 which flows through a path (represented by an arrow b3 in FIG. 2) from the end a2 of the first inductor 11 to the end a1 of the first inductor 11 through the capacitor 15, the diode 17, the capacitor 16, and the capacitor 14 in this order.

Additionally, energy stored in the second inductor 12 causes a current I4 which flows through a path (represented by an arrow b4 in FIG. 2) from the end a3 of the second inductor 12 to the end a4 of the second inductor 12 through the diode 17 and the capacitor 16 in this order.

Repetition of the above operations causes a DC voltage across the capacitor 16, and this DC voltage causes a current flowing through the LEDs 202 of the light emitting unit 20, thereby the LEDs 202 emitting light. In the present embodiment, the current I1 may be referred to as a first current, and the current I2 may be referred to as a second current.

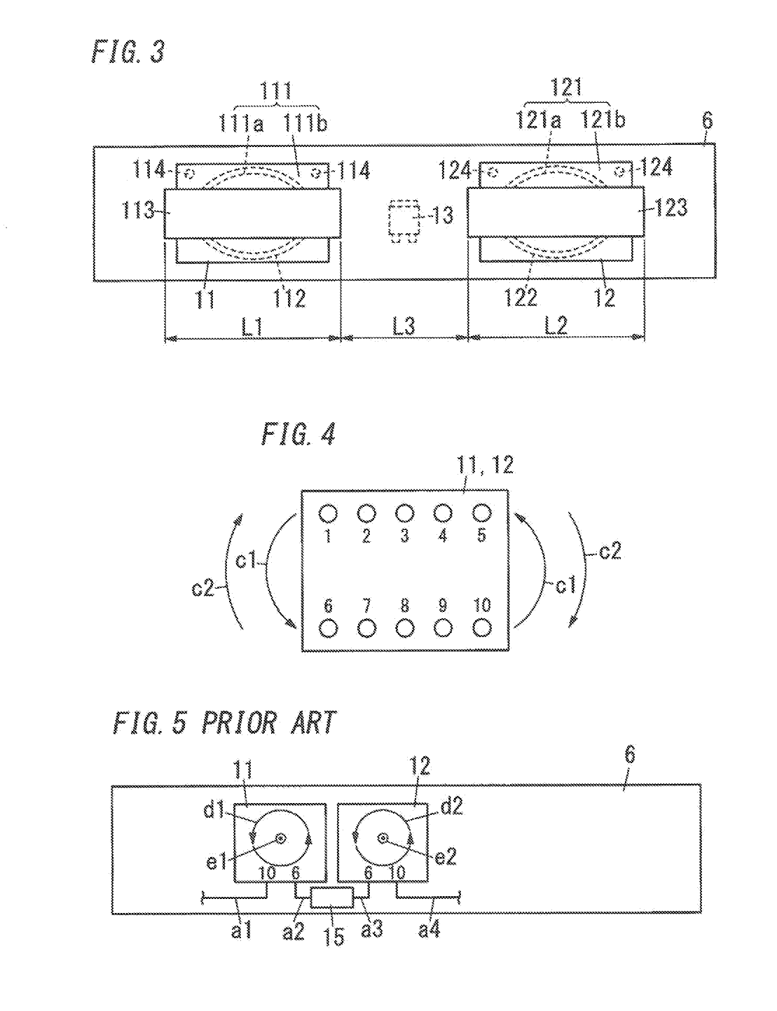

FIG. 3 is a plan view illustrating the first inductor 11, the second inductor 12, and the switching device 13 which are mounted on the substrate 6. In the following description, unless otherwise noted, an upward and downward direction and a left and right direction of FIG. 3 are respectively defined as an upward and downward direction and a left and right direction of the lighting device 10, and a direction perpendicular to the upward and downward direction and the left and right direction in FIG. 3 (i.e., a direction perpendicular to a sheet of FIG. 3) is defined as a forward and rearward direction of the lighting device 10 (the front side of the sheet corresponds to a front side of the lighting device 10). However, there is no intent to limit directions of the lighting device 10 to the above defined directions.

The first inductor 11 includes a bobbin 111 of synthetic resin. The bobbin 111 includes a cylindrical part 111a, and a pair of flange parts 111b. The cylindrical part 111a has a circular hollow cylindrical shape with an axial direction parallel to the forward and rearward direction. The pair of flange parts 111b each have a rectangular flat plate shape. The pair of flange parts 111b are attached to opposite ends of the cylindrical part 111a in the forward and rearward direction, individually.

There is a coil 112 which is of copper wire and is wound around the cylindrical part 111a of the bobbin 111, for example. Further, there is a pair of first coil terminals 114 arranged side by side in the left and right direction on an upper end of one of the pair of flange parts 111b of the bobbin 111. The pair of first coil terminals 114 are individually electrically connected to opposite ends of the coil 112. The bobbin 111 is held between a pair of cores 113 in the forward and rearward direction. The first inductor 11 is assembled in the above manner. The pair of cores 113 each have an E-shape when viewed in the upward and downward direction.

The second inductor 12 includes a bobbin 121, a coil 122, a pair of cores 123, and a pair of second coil terminals 124. The bobbin 121 includes a cylindrical part 121a, and a pair of flange parts 121b. Note that, the second inductor 12 has a similar configuration to the first inductor 11, and the explanations thereof thus are omitted. However, to distinguish between the second inductor 12 and the first inductor 11, components thereof are designated by different reference signs.

The first inductor 11 and the second inductor 12 are mounted on the substrate 6 (e.g., the front surface) so as to be spaced from each other at an interval L3 in a lengthwise direction of the substrate 6 (the left and right direction). In more detail, the first inductor 11 and the second inductor 12 are mounted on the substrate 6 with axial directions thereof being parallel to each other. Additionally, the first inductor 11 and the second inductor 12 are mounted on the substrate 6 so that the winding start points thereof are directed forward and the winding end points thereof are directed rearward. In summary, the first inductor 11 and the second inductor 12 are directed in the same direction in terms of the winding start points and the winding end points. Further, the switching device 13 is mounted on the substrate 6 (e.g., the rear surface) and positioned between the first inductor 11 and the second inductor 12 in the left and right direction of the substrate 6. In the present embodiment, the left and right direction of the substrate 6 represents the “arrangement direction”, referring herein to the direction in which the first inductor 11 and the second inductor 12 are arranged side by side.

As described above, the switching device 13 is mounted on the substrate 6 so as to be between the first inductor 11 and the second inductor 12 along the arrangement direction, and high-density packaging thus can be realized. Note that, the switching device 13 is mounted on the rear surface of the substrate 6 in the present embodiment but may be mounted on the front surface of the substrate 6. In summary, the switching device 13 may be mounted on the same surface of the substrate 6 on which the first inductor 11 and the second inductor 12 are mounted, or on a surface of the substrate 6 opposite the surface on which the first inductor 11 and the second inductor 12 are mounted.

Further, as shown in FIG. 3, each of the pair of first coil terminals 114 and the pair of second coil terminals 124 is mounted on the same edge (e.g., an upper edge) of the substrate 6 in a direction perpendicular to the arrangement direction, that is, the upward and downward direction. In contrast to a case where coil terminals are mounted on opposite edges of the substrate 6 in the upward and downward direction, an external dimension of the substrate 6 in the upward and downward direction can be smaller.

Additionally, as shown in FIG. 3, an external dimension L1 of the first inductor 11 in the arrangement direction (the left and right direction) is longer than the interval L3, and an external dimension L2 of the second inductor 12 in the arrangement direction (the left and right direction) is also longer than the interval L3. This can lead to interaction between a magnetic field (first magnetic field) produced by the first inductor 11 and a magnetic field (second magnetic field) produced by the second inductor 12.

FIG. 4 is a plan view of a model inductor for the first inductor 11 and the second inductor 12 when viewed from the back. The coil 112 of the first inductor 11 is wound in a counterclockwise direction when viewed from the back (a direction designated by an arrow c1 in FIG. 4). Note that, the sixth pin serves as the winding start point (corresponding to the end a1) of the coil 112 and the tenth pin serves as the winding end point (corresponding to the end a2) of the coil 112. In contrast, the coil 122 of the second inductor 12 is wound in a clockwise direction when viewed from the back (a direction designated by an arrow c2 in FIG. 4). Note that, the tenth pin serves as the winding start point (corresponding to the end a4) of the coil 122 and the sixth pin serves as the winding end point (corresponding to the end a3) of the coil 122. Note that, in FIG. 4, pins (first to fifth, and seventh to ninth pins) other than the sixth and tenth pins are depicted only for reference, and actually are not provided.

In contrast to the lighting device 10 of FIG. 2, a lighting device of a comparative example includes the coil 112 of the first inductor 11 in which the start position of winding and the end position of winding are interchanged. In other words, in the lighting device of the comparative example, the coil 112 of the first inductor 11 is wound in a clockwise direction when viewed from the back (the direction designated by the arrow c2 in FIG. 4). Note that, the tenth pin serves as the winding start point (corresponding to the end a1) of the coil 112 and the sixth pin serves as the winding end point (corresponding to the end a2) of the coil 112. In summary, directions of currents flowing through the coil 112 of the lighting device of the comparative example and the coil 112 of the lighting device 10 of FIG. 2 are opposite directions. Note that, other configurations and operations are similar to those of the lighting device 10 of FIG. 2.

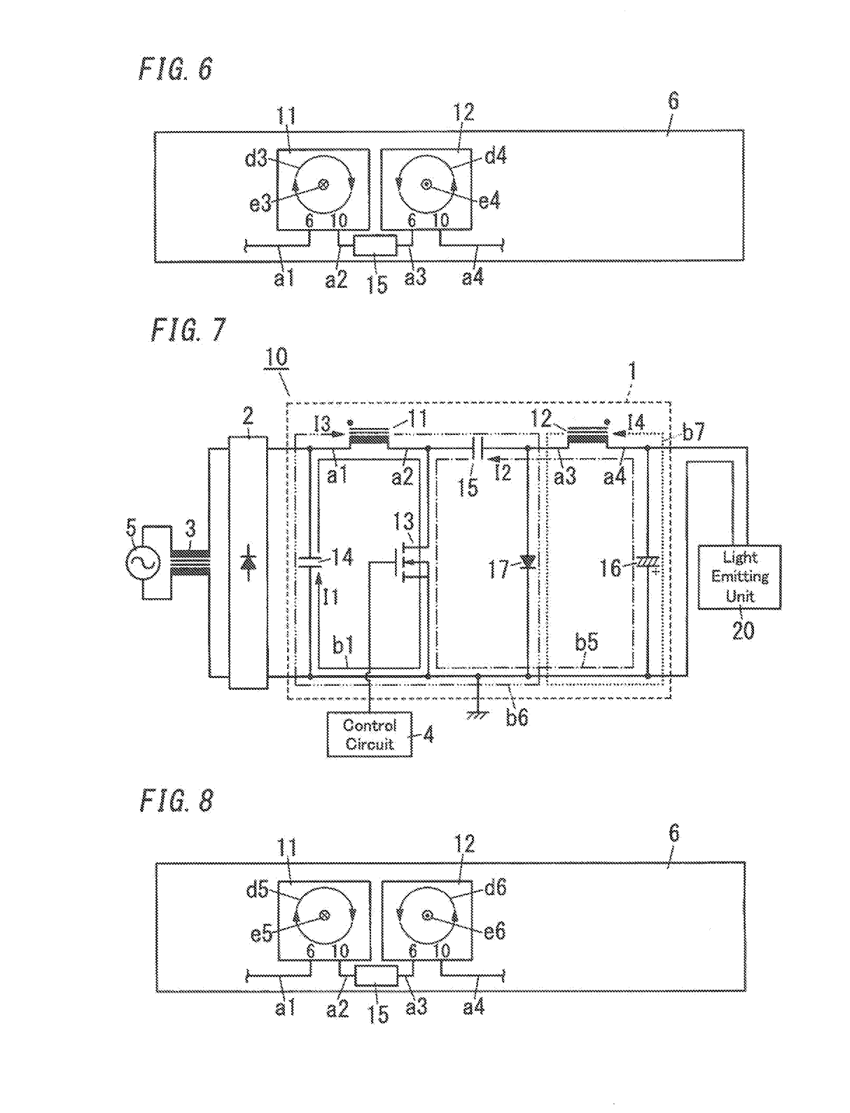

FIG. 5 is a plan view of the lighting device of the comparative example, illustrating a relationship between currents flowing through the first inductor 11 and the second inductor 12 and magnetic fields (first and second magnetic fields) caused by the currents. To simplify the illustration, the switching device 13 is not illustrated in FIG. 5. This may be applied to FIG. 6, FIG. 8, and FIG. 10.

As to the first inductor 11, a current flows from the tenth pin to the sixth pin. In more detail, a current flows through the coil 112 in a counterclockwise direction (a direction designated by an arrow d1 in FIG. 5), and this leads to generation of the magnetic field (first magnetic field) through the coil 112 in a direction from the back to the front (see a symbol e1 in FIG. 5). As to the second inductor 12, a current flows from the tenth pin to the sixth pin. In more detail, a current flows through the coil 122 in a counterclockwise direction (a direction designated by an arrow d2 in FIG. 5), and this leads to generation of the magnetic field (second magnetic field) through the coil 122 in a direction from the back to the front (see a symbol e2 in FIG. 5).

Consequently, the first magnetic field and the second magnetic field reinforce each other between the first inductor 11 and the second inductor 12, and this may result in an increase in a disturbance voltage caused by the first and second magnetic fields.

FIG. 6 is a plan view of the lighting device 10 of the present embodiment, illustrating a relationship between currents flowing through the first inductor 11 and the second inductor 12 and magnetic fields (first and second magnetic fields) caused by the currents.

As to the first inductor 11, a current flows through the coil 112 in a direction from the sixth pin (end a1) to the tenth pin (end a2). In other words, this current flows through the coil 112 in a clockwise direction (a direction designated by an arrow d3 in FIG. 6), and this leads to generation of the magnetic field (first magnetic field) through the coil 112 in a direction from the front to the back (see a symbol e3 in FIG. 6). As to the second inductor 12, a current flows through the coil 122 in a direction from the tenth pin (end a4) to the sixth pin (end a3). In other words, this current flows through the coil 122 in a counterclockwise direction (a direction designated by an arrow d4 in FIG. 6), and this leads to generation of the magnetic field (second magnetic field) through the coil 122 in a direction from the back to the front (see a symbol e4 in FIG. 6).

Consequently, the first magnetic field and the second magnetic field would cancel each other out between the first inductor 11 and the second inductor 12, and this may result in a decrease in a disturbance voltage caused by the first and second magnetic fields. Therefore, it is possible to reduce effects of the first and second magnetic fields on the switching device 13 placed between the first inductor 11 and the second inductor 12.

FIG. 7 is a circuit diagram of a lighting device 10 of the first modification of the present embodiment. The lighting device 10 of FIG. 2 includes the converter circuit 1 corresponding to a SEPIC circuit. However, the lighting device 10 of FIG. 7 includes the converter circuit 1 corresponding to a Cuk circuit. Note that, other components are same as those of the lighting device 10 of FIG. 2, and the same components are designated by the same reference signs to avoid redundant explanations thereof.

The lighting device 10 includes the converter circuit 1, the rectification circuit 2, the filter circuit 3, and the control circuit 4. The converter circuit 1 may correspond to a Cuk circuit, for example. The converter circuit 1 includes the first inductor 11, the second inductor 12, the switching device 13, the capacitors 14 to 16, and the diode 17.

The first inductor 11 has the end a1 (fixed before winding) electrically connected to the higher voltage side output terminal of the rectification circuit 2. The first inductor 11 has the end a2 (fixed after winding) electrically connected to the first end of the capacitor 15.

The capacitor 15 has the second end electrically connected to the end a3 (fixed after winding) of the second inductor 12. The second inductor 12 has the end a4 (fixed before winding) electrically connected to the negative electrode of the capacitor 16. The capacitor 16 has the positive electrode electrically connected to the lower voltage side output terminal of the rectification circuit 2.

The switching device 13 may be an N-channel MOSFET, for example. The switching device 13 has the drain electrically connected to the connection point of the first inductor 11 and the capacitor 15. The switching device 13 has the source electrically connected to the lower voltage side output terminal of the rectification circuit 2. Further, the switching device 13 has the gate electrically connected to the control circuit 4.

The diode 17 has the anode electrically connected to a connection point of the capacitor 15 and the second inductor 12. The diode 17 has the cathode electrically connected to the lower voltage side output terminal of the rectification circuit 2.

Hereinafter, operations of the lighting device 10 are described with reference to FIG. 7. When the switching device 13 is turned on according to the PWM signal from the control circuit 4, energy stored in the capacitor 14 causes the current II which flows through a path (represented by an arrow b1 in FIG. 7) from one end of the capacitor 14 to the other end of the capacitor 14 through the first inductor 11 and the switching device 13 in this order. Accordingly, electric energy would be stored in the first inductor 11.

Additionally, energy stored in the capacitor 15 causes the current I2 which flows through a path (represented by an arrow b5 in FIG. 7) from one end of the capacitor 15 to the other end of the capacitor 15 through the switching device 13, the capacitor 16, and the second inductor 12 in this order. Accordingly, electric energy would be stored in the second inductor 12.

When the switching device 13 is turned off according to the PWM signal from the control circuit 4, energy stored in the first inductor 11 causes the current I3 which flows through a path (represented by an arrow b6 in FIG. 7) from the end a2 of the first inductor 11 to the end a1 of the first inductor 11 through the capacitor 15, the diode 17, and the capacitor 14 in this order.

Additionally, energy stored in the second inductor 12 causes the current I4 which flows through a path (represented by an arrow b7 in FIG. 7) from the end a3 of the second inductor 12 to the end a4 of the second inductor 12 through the diode 17 and the capacitor 16 in this order.

Repetition of the above operations causes a DC voltage across the capacitor 16, and this DC voltage causes a current flowing through the LEDs 202 of the light emitting unit 20, thereby the LEDs 202 emitting light.

FIG. 8 is a plan view of the lighting device 10 of FIG. 7, illustrating a relationship between currents flowing through the first inductor 11 and the second inductor 12 and magnetic fields (first and second magnetic fields) caused by the currents.

As to the first inductor 11, a current flows through the coil 112 in a direction from the sixth pin (end a1) to the tenth pin (end a2). In other words, this current flows through the coil 112 in a clockwise direction (a direction designated by an arrow d5 in FIG. 8), and this leads to generation of the magnetic field (first magnetic field) through the coil 112 in a direction from the front to the back (see a symbol e5 in FIG. 8). As to the second inductor 12, a current flows through the coil 122 in a direction from the tenth pin (end a4) to the sixth pin (end a3). In other words, this current flows through the coil 122 in a counterclockwise direction (a direction designated by an arrow d6 in FIG. 8), and this leads to generation of the magnetic field (second magnetic field) through the coil 122 in a direction from the back to the front (see a symbol e6 in FIG. 8).

Consequently, the first magnetic field and the second magnetic field would cancel each other out between the first inductor 11 and the second inductor 12, and this may result in a decrease in a disturbance voltage caused by the first and second magnetic fields. Therefore, it is possible to reduce effects of the first and second magnetic fields on the switching device 13 placed between the first inductor 11 and the second inductor 12. Additionally, the switching device 13 is mounted on the substrate 6 so as to be between the first inductor 11 and the second inductor 12 in the arrangement direction (left and right direction), and high-density packaging thus can be realized.

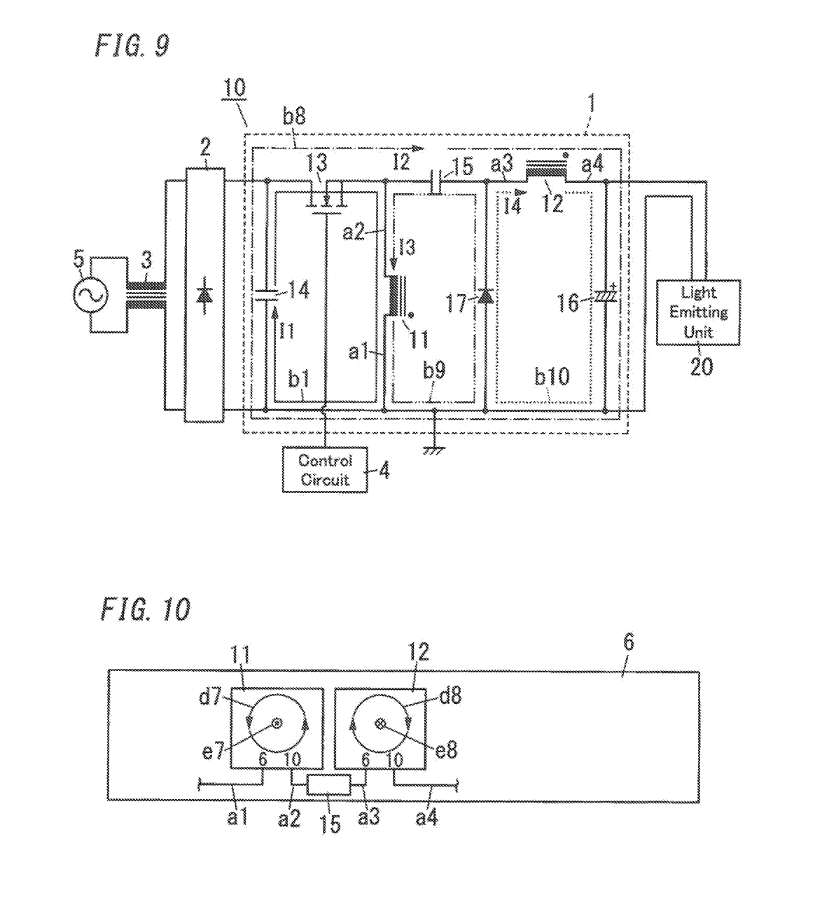

FIG. 9 is a circuit diagram of a lighting device 10 of the second modification of the present embodiment. The lighting device 10 of FIG. 2 includes the converter circuit 1 corresponding to a SEPIC circuit. However, the lighting device 10 of FIG. 9 includes the converter circuit 1 corresponding to a Zeta circuit. Note that, other components are same as those of the lighting device 10 of FIG. 2, and the same components are designated by the same reference signs to avoid redundant explanations thereof.

The lighting device 10 includes the converter circuit 1, the rectification circuit 2, the filter circuit 3, and the control circuit 4. The converter circuit 1 may correspond to a Zeta circuit, for example. The converter circuit 1 includes the first inductor 11, the second inductor 12, the switching device 13, the capacitors 14 to 16, and the diode 17.

The switching device 13 may be an N-channel MOSFET, for example. The switching device 13 has the drain electrically connected to the higher voltage side output terminal of the rectification circuit 2. The switching device 13 has the source electrically connected to the first end of the capacitor 15. Further, the switching device 13 has the gate electrically connected to the control circuit 4.

The capacitor 15 has the second end electrically connected to the end a3 (fixed after winding) of the second inductor 12. The second inductor 12 has the end a4 (fixed before winding) electrically connected to the positive electrode of the capacitor 16. The capacitor 16 has the negative electrode electrically connected to the lower voltage side output terminal of the rectification circuit 2.

The first inductor 11 has the end a2 (fixed after winding) electrically connected to a connection point of the switching device 13 and the capacitor 15. The first inductor 11 has the end a1 (fixed before winding) electrically connected to the lower voltage side output terminal of the rectification circuit 2.

The diode 17 has the cathode electrically connected to the connection point of the second inductor 12 and the capacitor 15. The diode 17 has the anode electrically connected to the lower voltage side output terminal of the rectification circuit 2.

Hereinafter, operations of the lighting device 10 are described with reference to FIG. 9. When the switching device 13 is turned on according to the PWM signal from the control circuit 4, energy stored in the capacitor 14 causes the current I1 which flows through a path (represented by an arrow b1 in FIG. 9) from one end of the capacitor 14 to the other end of the capacitor 14 through the switching device 13 and the first inductor 11 in this order. Accordingly, electric energy would be stored in the first inductor 11.

Additionally, energy stored in the capacitors 14 and 15 causes the current I2 which flows through a path (represented by an arrow b8 in FIG. 9) from one ends of the capacitors 14 and 15 to the other ends of the capacitors 14 and 15 through the second inductor 12 and the capacitor 16 in this order. Accordingly, electric energy would be stored in the second inductor 12.

When the switching device 13 is turned off according to the PWM signal from the control circuit 4, energy stored in the first inductor 11 causes the current I3 which flows through a path (represented by an arrow b9 in FIG. 9) from the end a1 of the first inductor 11 to the end a2 of the first inductor 11 through the diode 17 and the capacitor 15 in this order.

Additionally, energy stored in the second inductor 12 causes the current I4 which flows through a path (represented by an arrow b10 in FIG. 9) from the end a4 of the second inductor 12 to the end a3 of the second inductor 12 through the capacitor 16 and the diode 17 in this order.

Repetition of the above operations causes a DC voltage across the capacitor 16, and this DC voltage causes a current flowing through the LEDs 202 of the light emitting unit 20, thereby the LEDs 202 emitting light.

FIG. 10 is a plan view of the lighting device 10 of FIG. 9, illustrating a relationship between currents flowing through the first inductor 11 and the second inductor 12 and magnetic fields (first and second magnetic fields) caused by the currents.

As to the first inductor 11, a current flows through the coil 112 in a direction from the tenth pin (end a2) to the sixth pin (end a1). In other words, this current flows through the coil 112 in a counterclockwise direction (a direction designated by an arrow d7 in FIG. 10), and this leads to generation of the magnetic field (first magnetic field) through the coil 112 in a direction from the back to the front (see a symbol e7 in FIG. 10). As to the second inductor 12, a current flows through the coil 122 in a direction from the sixth pin (end a3) to the tenth pin (end a4). In other words, this current flows through the coil 122 in a clockwise direction (a direction designated by an arrow d8 in FIG. 10), and this leads to generation of the magnetic field (second magnetic field) through the coil 122 in a direction from the front to the back (see a symbol e8 in FIG. 10).

Consequently, the first magnetic field and the second magnetic field would cancel each other out between the first inductor 11 and the second inductor 12, and this may result in a decrease in a disturbance voltage caused by the first and second magnetic fields. Therefore, it is possible to reduce effects of the first and second magnetic fields on the switching device 13 placed between the first inductor 11 and the second inductor 12. Additionally, the switching device 13 is mounted on the substrate 6 so as to be between the first inductor 11 and the second inductor 12 in the arrangement direction (left and right direction), and high-density packaging thus can be realized.

Note that, the present embodiment is exemplified by the converter circuits 1 corresponding to an SEPIC circuit, a Cuk circuit, and a Zeta circuit. However, the converter circuit 1 is not limited to one of these circuits. In more detail, the converter circuit 1 may be modified, as long as the converter circuit 1 includes at least the first inductor 11, the second inductor 12, and the switching device 13 and is configured to allow currents to simultaneously flow through the switching device 13 by way of the first inductor 11 and the second inductor 12.

The technical concept of the present embodiment is described as being applied to the ceiling embedded lighting fixture. However, technical concept of the present embodiment can be applied to any other lighting fixture such as a ceiling attached lighting fixture to be attached to a surface of the ceiling material 9 and a wall-attached lighting fixture to be attached to a wall face.

As described above, the lighting device (10) of the first aspect according to the present disclosure includes a converter circuit (1), and a substrate (6). The converter circuit (1) includes at least a switching device (13), a first inductor (11), and a second inductor (12). At least the switching device (13), the first inductor (11), and the second inductor (12) are mounted on the substrate (6). The converter circuit (1) is configured to, when the switching device (13) is turned on, allow a first current (current I1) to flow through the switching device (13) by way of the first inductor (11) and allow a second current (current I2) to flow through the switching device (13) by way of the second inductor (12) in a direction same as a direction of the first current. The first inductor (11) includes a first coil (112). The second inductor (12) includes a second coil (122). The first inductor (11) and the second inductor (12) are mounted on the substrate (6) and arranged side by side along an arrangement direction so as to cause interaction between a first magnetic field produced by the first current flowing through the first inductor (11) and a second magnetic field produced by the second current flowing through the second inductor (12). The first coil (112) of the first inductor (11) and the second coil (122) of the second inductor (12) have winding directions such that the first magnetic field and the second magnetic field have a cancelling effect on each other. The switching device (13) is mounted on the substrate (6) so as to be present between the first inductor (11) and the second inductor (12) along the arrangement direction.

According to the first aspect, the first magnetic field and the second magnetic field would cancel each other out between the first inductor (11) and the second inductor (12), and this may result in a decrease in a disturbance voltage caused by the first and second magnetic fields. Therefore, it is possible to reduce effects of the first and second magnetic fields on the switching device (13) placed between the first inductor (11) and the second inductor (12). Additionally, the switching device (13) is mounted on the substrate (6) so as to be between the first inductor (11) and the second inductor (12) along the arrangement direction, and high-density packaging thus can be realized.

The lighting device (10) of the second aspect according to the present disclosure, which would be realized in combination with the first aspect, further includes a pair of first coil terminals (114), and a pair of second coil terminals (124). The pair of first coil terminals (114) are individually electrically connected to opposite ends of the first coil (112) of the first inductor (11). The pair of second coil terminals (124) are individually electrically connected to opposite ends of the second coil (122) of the second inductor (12). The pair of first coil terminals (114) and the pair of second coil terminals (124) are mounted on a same edge of the substrate (6) in a direction perpendicular to the arrangement direction.

According to the second aspect, in contrast to a case where coil terminals are mounted on opposite edges of the substrate (6) in the direction perpendicular to the arrangement direction, an external dimension of the substrate (6) in the direction perpendicular to the arrangement direction can be smaller. Note that, the second aspect is optional. For example, one of the pair of first coil terminals (114) and the pair of second coil terminals (124) may be mounted on a first edge of the substrate (6) in the arrangement direction, and the other may be mounted on a second edge of the substrate (6) in the arrangement direction.

The lighting device (10) of the third aspect according to the present disclosure, which would be realized in combination with the first or second aspect, satisfies relations of L3<L1 and L3<L2. L1 represents an external dimension of the first inductor (11) in the arrangement direction. L2 represents an external dimension of the second inductor (12) in the arrangement direction. L3 represents an interval between the first inductor (11) and the second inductor (12) in the arrangement direction.

According to the third aspect, the above dimensional relations are satisfied, and this can cause interaction between the first magnetic field and the second magnetic field. Note that, the third aspect is optional. For example, the lighting device (10) may satisfy relations of L3=L1 and L3=L2.

The lighting device (10) of the fourth aspect according to the present disclosure includes a converter circuit (1), a substrate (6), a pair of first coil terminals (114), and a pair of second coil terminals (124). The converter circuit (1) includes at least a switching device (13), a first inductor (11), and a second inductor (12). At least the switching device (13), the first inductor (11), and the second inductor (12) are mounted on the substrate (6). The first inductor (11) includes a first coil (112). The second inductor (12) includes a second coil (122). The pair of first coil terminals (114) are individually electrically connected to opposite ends of the first coil (112) of the first inductor (11). The pair of second coil terminals (124) are individually electrically connected to opposite ends of the second coil (122) of the second inductor (12). The converter circuit (1) is configured to, when the switching device (13) is turned on, allow a first current (current I1) to flow through the switching device (13) by way of the first inductor (11) and allow a second current (current I2) to flow through the switching device (13) by way of the second inductor (12) in a direction same as a direction of the first current. The first inductor (11) and the second inductor (12) are mounted on the substrate (6) and arranged side by side along an arrangement direction so as to cause interaction between a first magnetic field produced by the first current flowing through the first inductor (11) and a second magnetic field produced by the second current flowing through the second inductor (12). The first coil (112) of the first inductor (11) and the second coil (122) of the second inductor (12) have winding directions such that the first magnetic field and the second magnetic field have a cancelling effect on each other. The pair of first coil terminals (114) and the pair of second coil terminals (124) are mounted on a same edge of the substrate (6) in a direction perpendicular to the arrangement direction.

According to the fourth aspect, the first magnetic field and the second magnetic field would cancel each other out between the first inductor (11) and the second inductor (12), and it is thus possible to reduce a disturbance voltage caused by the first and second magnetic fields. Consequently, it is possible to reduce effects of the first and second magnetic fields on the switching device (13) placed between the first inductor (11) and the second inductor (12). Additionally, in contrast to a case where coil terminals are placed on opposite edges of the substrate (6) in the direction perpendicular to the arrangement direction, the external dimension of the substrate (6) in the direction perpendicular to the arrangement direction can be smaller.

The lighting device (10) of the fifth aspect according to the present disclosure includes a converter circuit (1), and a substrate (6). The converter circuit (1) includes at least a switching device (13), a first inductor (11), and a second inductor (12). At least the switching device (13), the first inductor (11), and the second inductor (12) are mounted on the substrate (6). The converter circuit (1) is configured to, when the switching device (13) is turned on, allow a first current (current I1) to flow through the switching device (13) by way of the first inductor (11) and allow a second current (current I2) to flow through the switching device (13) by way of the second inductor (12) in a direction same as a direction of the first current. The first inductor (11) includes a first coil (112). The second inductor (12) includes a second coil (122). The first inductor (11) and the second inductor (12) are mounted on the substrate (6) and arranged side by side along an arrangement direction so as to cause interaction between a first magnetic field produced by the first current flowing through the first inductor (11) and a second magnetic field produced by the second current flowing through the second inductor (12). The first coil (112) of the first inductor (11) and the second coil (122) of the second inductor (12) have winding directions such that the first magnetic field and the second magnetic field have a cancelling effect on each other. The lighting device (10) satisfies relations of L3<L1 and L3<L2. L1 represents an external dimension of the first inductor (11) in the arrangement direction. L2 represents an external dimension of the second inductor (12) in the arrangement direction. L3 represents an interval between the first inductor (11) and the second inductor (12) in the arrangement direction.

According to the fifth aspect, the above dimensional relations are satisfied, and this can cause interaction between the first magnetic field and the second magnetic field. Further, the first magnetic field and the second magnetic field have a cancelling effect on each other, and it is thus possible to reduce a disturbance voltage caused by the first and second magnetic fields. Consequently, the switching device (13) can be placed between the first inductor (11) and the second inductor (12).

The lighting fixture (100) of the sixth aspect according to the present disclosure includes the lighting device (10) of any one of the first to fifth aspects, and a light source (LEDs 202) configured to light with lighting power supplied from the lighting device (10).

According to the sixth aspect, the lighting device (10) is included and it is thus possible to provide the lighting fixture (100) capable of realizing high-density packaging and of reducing the disturbance voltage.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting device comprising:
a converter circuit including at least a switching device, a first inductor, and a second inductor; and
a substrate on which at least the switching device, the first inductor, and the second inductor are mounted,
the converter circuit being configured to, when the switching device is turned on, allow a first current to flow through the switching device by way of the first inductor and allow a second current to flow through the switching device by way of the second inductor in a direction same as a direction of the first current,
the first inductor including a first coil,
the second inductor including a second coil,
the first inductor and the second inductor being mounted on the substrate and arranged side by side along an arrangement direction so as to cause interaction between a first magnetic field produced by the first current flowing through the first inductor and a second magnetic field produced by the second current flowing through the second inductor,
the first coil of the first inductor and the second coil of the second inductor having winding directions such that the first magnetic field and the second magnetic field have a cancelling effect on each other, and
the switching device being mounted on the substrate so as to be present between the first inductor and the second inductor along the arrangement direction.

2. The lighting device of claim 1, further comprising:
a pair of first coil terminals individually electrically connected to opposite ends of the first coil of the first inductor; and
a pair of second coil terminals individually electrically connected to opposite ends of the second coil of the second inductor,
the pair of first coil terminals and the pair of second coil terminals being mounted on a same edge of the substrate in a direction perpendicular to the arrangement direction.

3. The lighting device of claim 1 satisfying relations of L3<L1 and L3<L2,
L1 representing an external dimension of the first inductor in the arrangement direction,
L2 representing an external dimension of the second inductor in the arrangement direction, and
L3 representing an interval between the first inductor and the second inductor in the arrangement direction.

4. A lighting device comprising:
a converter circuit including at least a switching device, a first inductor including a first coil, and a second inductor including a second coil;
a substrate on which at least the switching device, the first inductor, and the second inductor are mounted;
a pair of first coil terminals individually electrically connected to opposite ends of the first coil of the first inductor; and
a pair of second coil terminals individually electrically connected to opposite ends of the second coil of the second inductor,
the converter circuit being configured to, when the switching device is turned on, allow a first current to flow through the switching device by way of the first inductor and allow a second current to flow through the switching device by way of the second inductor in a direction same as a direction of the first current,
the first inductor and the second inductor being mounted on the substrate and arranged side by side along an arrangement direction so as to cause interaction between a first magnetic field produced by the first current flowing through the first inductor and a second magnetic field produced by the second current flowing through the second inductor,
the first coil of the first inductor and the second coil of the second inductor having winding directions such that the first magnetic field and the second magnetic field have a cancelling effect on each other, and
the pair of first coil terminals and the pair of second coil terminals being mounted on a same edge of the substrate in a direction perpendicular to the arrangement direction.

5. A lighting device comprising:
a converter circuit including at least a switching device, a first inductor, and a second inductor; and
a substrate on which at least the switching device, the first inductor, and the second inductor are mounted,
the converter circuit being configured to, when the switching device is turned on, allow a first current to flow through the switching device by way of the first inductor and allow a second current to flow through the switching device by way of the second inductor in a direction same as a direction of the first current,
the first inductor including a first coil,
the second inductor including a second coil,
the first inductor and the second inductor being mounted on the substrate and arranged side by side along an arrangement direction so as to cause interaction between a first magnetic field produced by the first current flowing through the first inductor and a second magnetic field produced by the second current flowing through the second inductor,
the first coil of the first inductor and the second coil of the second inductor having winding directions such that the first magnetic field and the second magnetic field have a canceling effect on each other,
the lighting device satisfying relations of L3<L1 and L3<L2,
L1 representing an external dimension of the first inductor in the arrangement direction,
L2 representing an external dimension of the second inductor in the arrangement direction, and
L3 representing an interval between the first inductor and the second inductor in the arrangement direction.

6. A lighting fixture comprising:
the lighting device of claim 1; and
a light source configured to light with lighting power supplied from the lighting device.

7. A lighting fixture comprising:
the lighting device of claim 4; and
a light source configured to light with lighting power supplied from the lighting device.

8. A lighting fixture comprising:
the lighting device of claim 5; and
a light source configured to light with lighting power supplied from the lighting device.
